(19) United States
(12) Patent Application Publication
(10) Pub. No.: US 2021/0341787 A1
(43) Pub. Date: Nov. 4, 2021

(54) CIRCULARLY POLARIZING PLATE, METHOD FOR PRODUCING CIRCULARLY POLARIZING PLATE, DISPLAY DEVICE AND METHOD FOR PRODUCING DISPLAY DEVICE

(71) Applicant: SHARP KABUSHIKI KAISHA, Sakai City, Osaka (JP)

(72) Inventors: MASAHIRO HASEGAWA, Sakai City, Osaka (JP); MIHO YAMADA, Sakai City, Osaka (JP); AKIRA SAKAI, Sakai City, Osaka (JP)

(21) Appl. No.: 17/279,543

(22) PCT Filed: Sep. 28, 2018
(86) PCT No.: PCT/JP2018/036349

§ 371 Date: Mar. 24, 2021

(51) Int. Cl. G02F 1/1335; G02F 1/13363; G02F 1/1337

(52) U.S. Cl. CPC G02F 1/133541; G02F 1/133723; G02F 1/133638

(57) ABSTRACT

A circular polarizer according to the disclosure includes a λ/4 layer, and a polarization layer that is layered on the λ/4 layer and includes a lyotropic liquid crystal, and an overcoat layer covering an upper surface and a side surface of the polarization layer and a side surface of the λ/4 layer is formed.

### TECHNICAL FIELD

The present invention relates to a circular polarizer, a method for manufacturing a circular polarizer, a display device, and a method for manufacturing a display device.

### BACKGROUND ART

For example, PTL 1 described below discloses a circular polarizer using a lyotropic liquid crystal. Further, the lyotropic liquid crystal described above is a water-soluble material, and, for example, due to an influence of moisture in the air, a polarization characteristics deteriorates, and the lyotropic liquid crystal itself dissolves. Thus, for example, in PTL 1 described above, it is proposed to provide an overcoat layer.

### CITATION LIST

### Patent Literature

PTL 1: JP 2014-206681 A (published on Oct. 30, 2014)

### SUMMARY OF INVENTION

### Technical Problem

For the conventional circular polarizer as described above, it is known that the circular polarizer is manufactured by successively layering a λ/4 layer and a polarization layer using a lyotropic liquid crystal on a support substrate such as a glass substrate, for example, by an application form.

However, in the conventional circular polarizer as described above, there is a case where the overcoat layer cannot be appropriately provided on the polarization layer. Particularly, when productivity of the circular polarizer is increased by simultaneously forming a plurality of circular polarizers on one support substrate and dividing the circular polarizer into individual circular polarizers, there is a case where the overcoat layer cannot be appropriately provided on the polarization layer, and there is a problem that performance of the circular polarizer significantly decreases.

In light of the problem described above, an object of the present invention is to provide a circular polarizer, a method for manufacturing a circular polarizer, a display device, and a method for manufacturing a display device that can prevent performance of a circular polarizer from decreasing even when productivity of the circular polarizer is increased.

### Solution to Problem

In order to solve the problem described above, a circular polarizer according to an aspect of the present invention includes a λ/4 layer, and a polarization layer that is layered on the λ/4 layer and includes a lyotropic liquid crystal, wherein an overcoat layer covering an upper surface and a side surface of the polarization layer and a side surface of the λ/4 layer is formed.

Further, a method for manufacturing a circular polarizer according to an aspect of the present invention includes a λ/4 layer forming step of forming a λ/4 layer, a polarization layer forming step of forming, on the λ/4 layer, a polarization layer including a lyotropic liquid crystal, and an overcoat layer forming step of forming an overcoat layer covering an upper surface and a side surface of the polarization layer and a side surface of the λ/4 layer.

Further, a method for manufacturing a display device according to an aspect of the present invention includes a resin layer forming step of forming a resin layer, a barrier layer forming step of forming a barrier layer on the resin layer; a thin film transistor (TFT) layer forming step of forming a TFT layer on the barrier layer; a light-emitting element layer forming step of forming a light-emitting element layer; a sealing layer forming step of forming a sealing layer on the light-emitting element layer; and a circular polarizer forming step of forming a circular polarizer on the sealing layer, wherein the circular polarizer includes a λ/4 layer, and a polarization layer that is layered on the λ/4 layer and includes a lyotropic liquid crystal, and an overcoat layer covering an upper surface and a side surface of the polarization layer and a side surface of the λ/4 layer is formed.

### Advantageous Effects of Invention

An aspect of the present invention can prevent performance of a circular polarizer from decreasing even when productivity of the circular polarizer is increased.

### BRIEF DESCRIPTION OF DRAWINGS

FIG. 1 is a cross-sectional view illustrating a configuration of a circular polarizer according to a first embodiment of the present invention.

FIG. 2 is a cross-sectional view illustrating another configuration of the circular polarizer according to the first embodiment of the present invention.

(a) of FIG. 3 is a plan view illustrating an example of a configuration of a circular polarizer according to a second embodiment of the present invention during manufacturing. (b) of FIG. 3 is a cross-sectional view illustrating a configuration of the circular polarizer according to the second embodiment of the present invention during manufacturing.

FIG. 4 is a flowchart illustrating an example of a method for manufacturing a circular polarizer according to the second embodiment of the present invention.

FIG. 5 is a schematic view illustrating a technique for manufacturing a circular polarizer according to a third embodiment of the present invention.

FIG. 6 is a schematic view illustrating a technique for manufacturing a circular polarizer according to a fourth embodiment of the present invention.

FIG. 7 is a schematic view illustrating a technique for manufacturing a circular polarizer according to a fifth embodiment of the present invention.

FIG. 8 is a cross-sectional view illustrating a configuration of a circular polarizer according to a sixth embodiment of the present invention during manufacturing.

FIG. 9 is a top view of a display device according to an eighth embodiment of the present invention.

FIG. 10 is a cross-sectional view taken along a line B-B illustrating a configuration example of a display region of the display device according to the eighth embodiment of the present invention.

FIG. 11 is a flowchart illustrating an example of a method for manufacturing a display device according to a ninth embodiment of the present invention.

FIG. 12 is a flowchart illustrating an example of a circular polarizer forming step in a method for manufacturing a display device according to a tenth embodiment of the present invention.

### Description of Embodiments

### First Embodiment: Circular Polarizer 1 and Method for Manufacturing Circular Polarizer 1 Circular Polarizer 1

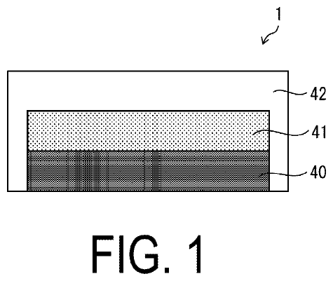

Hereinafter, an embodiment of the present invention will be described in detail. FIG. 1 is a cross-sectional view illustrating a configuration of a circular polarizer according to a first embodiment of the present invention.

In FIG. 1, a circular polarizer 1 according to the first embodiment includes a λ/4 layer 40, and a polarization layer 41 that is layered on the λ/4 layer 40 and includes a lyotropic liquid crystal, and an overcoat layer (hereinafter also referred to as an OC layer) 42 covering an upper surface and a side surface of the polarization layer 41 and a side surface of the λ/4 layer 40 is formed.

The λ/4 layer 40 and the polarization layer 41 are each formed as a plate-like or film-like member having a rectangular shape.

### λ/4 Layer 40

The λ/4 layer 40 is a layer having an optical function of providing a predetermined phase difference (retardation) to linearly polarized light. The λ/4 layer 40 is formed from a composition including a polymer such as a polyolefin-based resin, a cyclic olefin-based resin, a polycarbonate-based resin, and a liquid crystal compound.

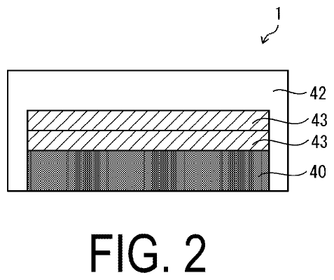

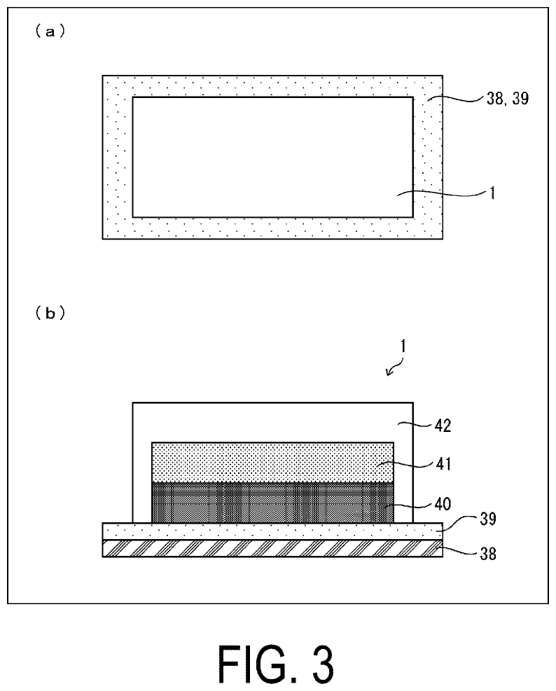

The λ/4 layer 40 provides a phase difference of π/2 (=λ/4) to a polarization face of incident light, for example. Note that, in addition to the description, for example, as illustrated in FIG. 2, the λ/4 layer 40 may be a layered body that provides a phase difference of π=λ/2) to the polarization face of incident light and on which two λ/2 layers 43 are layered.

A film thickness of the λ/4 layer 4040 is preferably equal to or less than 50 μm, is more preferably equal to or less than 20 μm, and is even more preferably equal to or less than 10 μm.

Further, an in-plane phase difference value (Re value) of the λ/4 layer 40 at a wavelength of 550 nm is not limited to 137.5 nm. A range of an in-plane phase difference applicable to the λ/4 layer 40 may be a range of the in-plane phase difference value of 120 to 160 nm at the wavelength of 550 nm.

Further, in a case of the λ/2 layer 43, an in-plane phase difference value may fall in a range of 250 to 300 nm at the wavelength of 550 nm.

Further, the λ/4 layer 40 may be a layer formed from a polymer such as a liquid crystal workpiece in which molecules are oriented in a normal direction. Such a λ/4 layer 40 can be applied to, for example, a side opposite to a surface of the λ/4 layer 40 on which the polarization layer 41 is layered when a positive C plate is layered in order to improve a viewing angle of reflection and the like.

Further, when the λ/4 layer 40 is configured as a single layer, a material exhibiting a reverse wavelength dispersion characteristic in which λ/4 increases with an increase in wavelength is preferable. By using such a material, a tinge of reflection in a front view can be improved.

### Polarization Layer 41

The polarization layer 41 is a layer that includes a lyotropic liquid crystal, and transmits only a polarized wave or polarized light in a specific direction. The polarization layer 41 is formed from a composition including a lyotropic liquid crystal. Here, the lyotropic liquid crystal generally refers to another component-based liquid crystal in which a main molecule forming a liquid crystal dissolves in a solvent (such as water or an organic solvent) having other properties.

The lyotropic liquid crystal is one type of a pigment compound that exhibits dichroism, and can be brought into a liquid crystal state by adding an appropriate solvent to change the concentration thereof. Examples of the lyotropic liquid crystal include a lyotropic chromonic liquid crystal (hereinafter also referred to as an “LCLC”).

A film thickness of the polarization layer 41 is preferably equal to or less than 2 μm, is more preferably equal to or less than 1.5 μm, and is even more preferably equal to or less than 1 μm.

Note that one or more additional optional layers may be provided between the λ/4 layer 40 and the polarization layer 41. However, the additional layer may not inhibit the functions of the λ/4 layer 40 and the polarization layer 41, and it is preferable that the additional layer is not provided from a viewpoint of making the circular polarizer 1 a thinner layer. Examples thereof include a layer such as a transparent polyimide.

### OC layer 42

The OC layer 42 is provided so as to cover the upper surface and the side surface of the polarization layer 41 and the side surface of the λ/4 layer 40. Specific examples of a material for the OC layer 42 include a polyimide-based, epoxy-based, or acrylic-based ultraviolet (UV) curable transparent resin, a thermosetting transparent resin, a transparent resin having natural curing properties, or the like.

A film thickness of the OC layer 42 is preferably 1 to 5 μm, is more preferably 1 to 4 μm, and is even more preferably 2 to 3 μm. Further, the OC layer 42 may be formed by layering two or more OC layers that are different from each other or are the same.

The circular polarizer 1 may further include a hard coat (HC) layer on a surface of the OC layer 42 and a surface of the polarization layer 41.

Examples of a material for the hard coat (HC) layer include an ultraviolet curable resin, a thermosetting resin, and the like of a melamine resin, a urethane resin, and an acrylic resin.

A film thickness of the hard coat (HC) layer is preferably 2 to 20 μm, is more preferably 2 to 15 μm, and is even more preferably 5 to 10 μm.

### Method for Manufacturing Circular Polarizer 1

Next, an example of a method for manufacturing the circular polarizer 1 will be described. The method for manufacturing the circular polarizer 1 includes a λ/4 layer forming step of forming the λ/4 layer 40, a polarization layer forming step of forming, on the λ/4 layer 40, the polarization layer 41 including a lyotropic liquid crystal, and an OC layer forming step of forming the OC layer 42 covering the upper surface and the side surface of the polarization layer 41 and the side surface of the λ/4 layer 40.

### λ/4 Layer Forming Step

First, the λ/4 layer 40 is formed by using a material for the λ/4 layer 40. The λ/4 layer 40 is formed by applying the material for the λ/4 layer 40 on a support substrate. Specifically, the λ/4 layer 40 is formed by applying the material for the λ/4 layer 40, then heating the material at 80° C., and then irradiating the material with ultraviolet light.

### Polarization Layer Forming Step

Then, a material (for example, a composition including a lyotropic liquid crystal) for the polarization layer 41 is applied onto the λ/4 layer 40, and the polarization layer 41 is formed. In an example, a composition including a lyotropic liquid crystal is applied and then dried naturally.

### OC Layer Forming Step

Subsequently, the OC layer 42 is formed so as to cover the upper surface and the side surface of the polarization layer 41 and the side surface of the λ/4 layer 40. In an example, the OC layer 42 is formed by application on the upper surface and the side surface of the polarization layer 41 and the side surface of the λ/4 layer 40. A known curing method can be used as a method for curing the OC layer 42, which is appropriately selected depending on a material to be used. Examples thereof include a method of curing by heat, a method of curing by ultraviolet light, a method of curing by visible light, a method of curing by laser light, and the like. In an example, it is preferable to use a curing method without heat or a curing method at a lower temperature, such as the method of curing by ultraviolet light and the method of curing by visible light. By using the curing method without heat in such a manner, an influence of heat on the polarization layer 41 can be suppressed. In an example, the OC layer 42 is heated at 80° C. and is then cured by ultraviolet irradiation. Further, in another example, the OC layer 42 is heated at a temperature equal to or higher than 80° C. and is thus cured.

For application of a material in each of the steps described above, a method such as spin coating, slit coating, casting, die coating, and ink jet can be applied as appropriate according to a type and a property of the material.

### Dividing Step

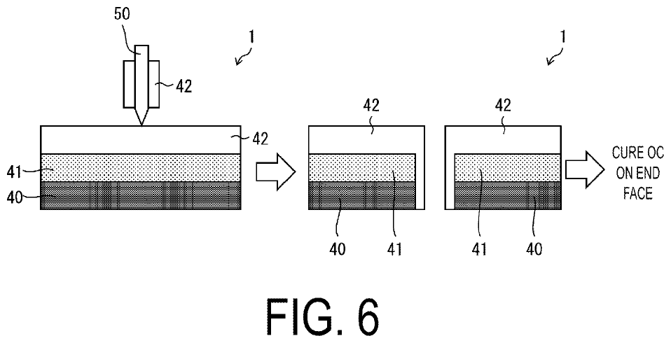

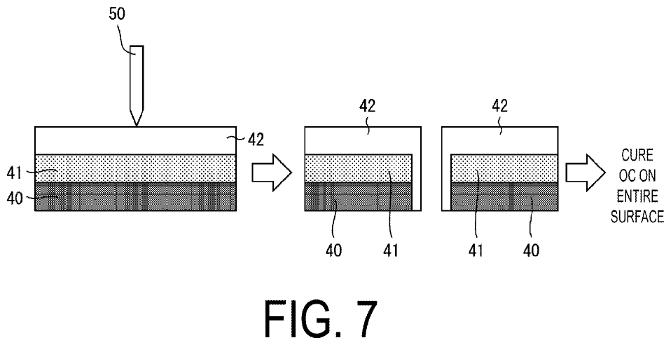

In an example of the method for manufacturing a circular polarizer, a dividing step of dividing the circular polarizer 1 is further included. In the dividing step, the circular polarizer 1 of a large size is divided into a desired size. The division is performed by, for example, a division blade 50 illustrated in FIGS. 6 and 7 described below. The dividing step may be performed before the OC layer forming step, may be performed during the OC layer forming step performed for a plurality of times, and the division and the formation of the OC layer 42 may be performed simultaneously. Each of the aspects will be described in each of the embodiments below.

As described above, in the circular polarizer 1 according to the present embodiment, the upper surface and the side surface of the polarization layer 41 of the circular polarizer 1 and the side surface of the λ/4 layer 40 are covered with and protected by the OC layer 42. Thus, moisture entering a cut surface of the circular polarizer, and a polarization characteristic deteriorating from the side surface of the circular polarizer can be suppressed. Further, deformation of the circular polarizer can be prevented, and mechanical strength can also be increased. Thus, a polarization characteristic can be maintained over a long period of time.

### Second Embodiment: Method for Manufacturing Circular Polarizer

Next, an example of a method for manufacturing a circular polarizer according to a second embodiment will be described.

The method for manufacturing according to the second embodiment relates to a method for manufacturing a circular polarizer by simultaneously forming a plurality of circular polarizers on one support substrate, and dividing the circular polarizer into individual circular polarizers. For example, an aspect is adopted where a circular polarizer of a large size can be formed on one support substrate and then divided into individual pieces of the circular polarizer.

(a) of FIG. 3 is a plan view illustrating an example of a configuration of the circular polarizer according to the second embodiment during manufacturing. As illustrated in (a) of FIG. 3, a circular polarizer 1 of a large size is formed on a support substrate 38. A resin layer 39 is provided on an entire surface of the support substrate 38. (b) of FIG. 3 is a cross-sectional view illustrating a configuration of the circular polarizer 1 according to the second embodiment during manufacturing. In the configuration of (b) of FIG. 3, the support substrate 38, the resin layer 39, a λ/4 layer 40, and a polarization layer 41 that is layered on the λ/4 layer 40 and includes a lyotropic liquid crystal are included, and an OC layer 42 covering an upper surface and a side surface of the polarization layer 41 and a side surface of the λ/4 layer 40 is formed.

An example of the method for manufacturing a circular polarizer according to the second embodiment includes a resin layer forming step of forming the resin layer 39 on the support substrate 38, a λ/4 layer forming step of forming the λ/4 layer 40 on the resin layer 39, a polarization layer forming step of forming, on the λ/4 layer 40, the polarization layer 41 including a lyotropic liquid crystal, and an OC layer forming step of forming the OC layer 42 covering the upper surface and the side surface of the polarization layer 41 and the side surface of the λ/4 layer 40. Further, in an example of the method for manufacturing a circular polarizer, a dividing step of dividing the circular polarizer 1 is further included. Note that the description in the first embodiment applies to each material and configuration of the λ/4 layer 40, the polarization layer 41, the steps of forming the λ/4 layer 40 and the polarization layer 41, the dividing step, and the like. The same also applies to the second embodiment and the following embodiments.

A transparent substrate capable of transmitting visible light is used for the support substrate 38. Examples of the transparent substrate include an inorganic material substrate formed from glass, quartz, or the like, a plastic substrate formed from polyethylene terephthalate, polyethylene naphthalate, polycarbazole, polyimide, or the like, and the like. Further, an inorganic material substrate such as glass is preferable from a viewpoint of moisture barrier properties and gas barrier properties. On the other hand, when a plastic substrate is used, a substrate in which an inorganic material is coated on the plastic substrate is preferable from a viewpoint of improving gas barrier properties.

For the resin layer 39, specific examples of a material for the resin layer include a transparent polyimide. For example, the transparent polyimide is used as a base material for serving as a flexible substrate and forming each layer of an organic EL (OLED) in an OLED display device.

Further, in an example of the method for manufacturing a circular polarizer according to the second embodiment, in the λ/4 layer forming step, the λ/4 layer 40 is formed on the resin layer 39 on the support substrate 38 by application, and, in the polarization layer forming step, the polarization layer 41 is formed on the λ/4 layer 40 by application.

In another example of the method for manufacturing a circular polarizer according to the second embodiment, in the OC layer forming step, the OC layer 42 described above is further formed on, by application, the upper surface and the side surface of the polarization layer 41 and the side surface of the λ/4 layer 40.

Further, for the resin layer 39, a peeling layer such as molybdenum instead of polyimide may be provided between the support substrate 38 and the λ/4 layer 40. Such a peeling layer remains on the support substrate 38 side, such as a glass substrate, when laser lift-off (LLO) is performed, and does not adhere to the λ/4 layer 40. In this case, a circular polarizer that does not include the resin layer 39 such as polyimide can be manufactured.

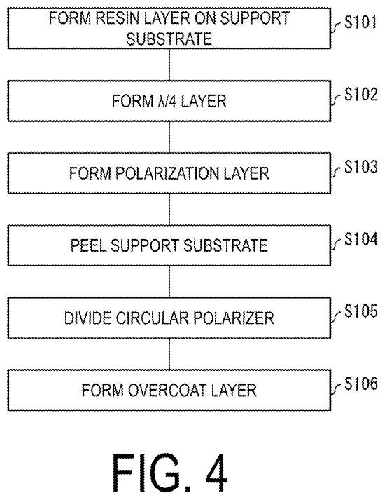

The method for manufacturing a circular polarizer according to the second embodiment will be described in detail with reference to a flowchart in FIG. 4.

First, the resin layer 39 is formed on the support substrate 38 (step S101). At this time, the resin layer 39 is formed by applying a transparent polyimide onto the support substrate 38 made of glass or the like, for example, and then being heated (for example, at 260° C.).

Next, the λ/4 layer 40 is formed on the resin layer 39 (step S102). Next, the polarization layer 41 is formed on the λ/4 layer 40 (step S103).

Next, the support substrate 38 is peeled from the resin layer 39 (step S104). Peeling of the support substrate 38 may be performed by, for example, a technique (LLO: Laser Lift Off) for irradiating a lower surface of the resin layer 39 with laser light over the support substrate 38, reducing a bonding force between the support substrate 38 and the resin layer 39, and peeling the support substrate 38 from the resin layer 39.

Next, the circular polarizer 1 of a large size is divided (step S105).

Next, the OC layer 42 is formed so as to cover the upper surface and the side surface of the divided polarization layer 41 and the side surface of the λ/4 layer 40 (step S106).

Here, the dividing step in step S105 may be performed before peeling from the support substrate 38, or may be performed after peeling from the support substrate 38. In other words, steps S104 and S105 may be replaced with each other in order. In other words, after step S103, the circular polarizer 1 together with the support substrate 38 may be divided without peeling the support substrate 38 from the resin layer 39, the support substrate 38 may be then peeled from the resin layer 39, and the OC layer 42 may be subsequently provided.

As described above, the method for manufacturing a circular polarizer according to the present embodiment can manufacture the circular polarizer in which the upper surface and the side surface of the polarization layer 41 and the side surface of the λ/4 layer 40 are covered with and protected by the OC layer 42.

By manufacturing individual pieces of the circular polarizer from the circular polarizer of a large size in such a manner, productivity can be increased, and, at the same time, the circular polarizer with a decrease in performance being suppressed can be manufactured.

### Third Embodiment: Technique 1 of Method for Manufacturing Circular Polarizer

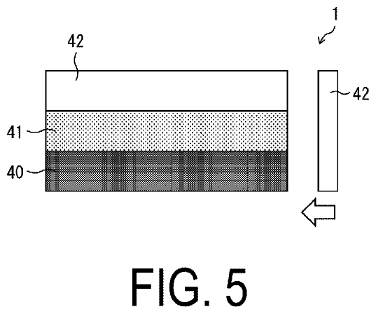

FIG. 5 is a schematic view illustrating a technique for manufacturing a circular polarizer 1 according to a third embodiment of the present invention.

A method for manufacturing the circular polarizer 1 according to the third embodiment further includes a dividing step of dividing the circular polarizer 1, and, in an OC layer forming step, an OC layer 42 covering an upper surface of a polarization layer 41 is provided, the circular polarizer 1 is then divided, and the OC layer 42 covering a side surface of the polarization layer 41 is further formed.

In the OC layer forming step in the third embodiment, a material for the OC layer 42 is applied to the upper surface of the polarization layer 41, and the OC layer 42 is formed. The obtained circular polarizer 1 is divided into a desired size, a material for the OC layer 42 is applied to the side surface of the circular polarizer 1, and the OC layer 42 is formed. In this way, the upper surface and the side surface of the polarization layer 41 and the side surface of the λ/4 layer 40 can be covered with the OC layer 42. Note that the OC layer 42 on the upper surface of the polarization layer 41 is cured before the division. The OC layer 42 on the side surface is cured after the formation of the OC layer 42 on the side surface.

### Fourth Embodiment: Technique 2 of Method for Manufacturing Circular Polarizer

FIG. 6 is a schematic view illustrating a technique for manufacturing a circular polarizer 1 according to a fourth embodiment of the present invention.

A method for manufacturing a circular polarizer according to the fourth embodiment further includes a dividing step of dividing the circular polarizer 1, the dividing step is performed by using the division blade 50 on which a material for an OC layer 42 is applied, and, in an OC layer forming step, the OC layer 42 is formed by providing the OC layer 42 so as to cover an upper surface of a polarization layer 41 and a side surface of a λ/4 layer 40, then dividing the circular polarizer 1 with the division blade 50, and thus covering, with the material for the OC layer 42 applied to the division blade 50, a side surface of the polarization layer 41 and a side surface of the λ/4 layer 40. The material for the OC layer 42 applied to the division blade 50 is in a state prior to curing before the dividing step. In an example, after the OC layer 42 formed so as to cover the upper surface of the polarization layer 41 is cured, the circular polarizer 1 is divided. Next, the OC layer 42 on the side surface after the division is cured.

### Fifth Embodiment: Technique 3 of Method for Manufacturing Circular Polarizer

FIG. 7 is a schematic view illustrating a technique for manufacturing a circular polarizer 1 according to a fifth embodiment of the present invention.

A method for manufacturing a circular polarizer according to the fifth embodiment further includes a dividing step of dividing the circular polarizer 1, the dividing step is performed by using the division blade 50 on which a material for an OC layer 42 is not applied, and, in an OC layer forming step, the OC layer 42 is formed by providing the OC layer 42 so as to cover an upper surface of a polarization layer 41, then dividing the circular polarizer 1 with the division blade 50 before the OC layer 42 is cured, and thus covering, with the material for the OC layer 42 on the upper surface of the polarization layer 41, a side surface of the polarization layer 41 and a side surface of a λ/4 layer 40. In an example, after the division of the circular polarizer 1, the OC layer 42 on an entire surface (the upper surface and the side surface) of the circular polarizer 1 is cured.

According to the method for manufacturing according to the fourth and fifth embodiments, the OC layer forming step of covering the side surface of the polarization layer 41 is performed simultaneously with the division in the dividing step of the division blade 50, and can thus be omitted. Thus, time and a cost for performing the OC layer forming step again as a separate step from the OC layer forming step of covering the upper surface of the polarization layer 41 can be reduced.

Further, in the method for manufacturing according to the fourth embodiment, a film thickness of the OC layer 42 applied to the side surface of the polarization layer 41 can be easily adjusted to a desired thickness. Further, in the method for manufacturing according to the fifth embodiment, the step of applying the material for the OC layer 42 to the division blade 50 can be further omitted. In this way, the fourth and fifth embodiments can be selected according to a purpose, a material of each layer, and the like.

The method for manufacturing a circular polarizer according to each of the embodiments described above can be suitably applied in a method for dividing the circular polarizer 1 of a large size into individual pieces of the circular polarizer 1, and producing the polarizer 1.

### Sixth Embodiment: Technique 4 of Method for Manufacturing Circular Polarizer

In an example of a method for manufacturing a circular polarizer, individual pieces of a plurality of circular polarizers 1 can be produced by simultaneously dividing the plurality of circular polarizers 1 of a large size overlapping each other.

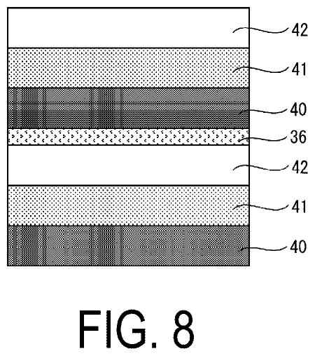

FIG. 8 is a cross-sectional view illustrating a configuration of a circular polarizer according to a sixth embodiment of the present invention during manufacturing.

The method for manufacturing a circular polarizer according to the sixth embodiment further includes a liquid repellent layer forming step of forming, between an OC layer 42 and a λ/4 layer 40, a liquid repellent layer 36 that repels a material for the OC layer 42, and the plurality of circular polarizers 1 are layered together and formed with the liquid repellent layer 36 interposed between the two circular polarizers 1. In other words, the liquid repellent layer 36 is formed between the OC layer 42 and the λ/4 layer 40 adjacent to each other by overlapping and layering the two circular polarizers 1 of a large size. A material for the liquid repellent layer 36 is appropriately selected according to a type of a material of the OC layer 42, and the like.

An example of the method for manufacturing a circular polarizer according to the sixth embodiment further includes a dividing step of dividing the layered circular polarizers 1 described above. The embodiment described above can be applied to the dividing step.

Since the liquid repellent layer 36 repels the OC layer 42, the plurality of layered circular polarizers 1 of a large size can be prevented from adhering to each other. Further, by simultaneously dividing the plurality of circular polarizers of a large size, productivity can be further increased.

### Seventh Embodiment: Technique 5 of Method for Manufacturing Circular Polarizer

In a method for manufacturing a circular polarizer according to a seventh embodiment, a composition including a lyotropic liquid crystal (for example, an LCLC) is applied to an entire surface of a λ/4 layer 40, and a polarization layer 41 (for example, an LCLC layer) is formed. Next, the formed polarization layer 41 (for example, the LCLC layer) is patterned by dry etching such as photolithography and reactive ion etching (RIE), or the like. After patterning, a material for an OC layer 42 is applied to an entire surface, and the OC layer 42 is formed. Here, the material for the OC layer 42 may be applied by ink-jet or the like. In still another embodiment, a composition including a lyotropic liquid crystal (for example, an LCLC) is applied to an entire surface of a λ/4 layer 40, and a polarization layer 41 (for example, a LCLC layer) is formed. A material for an OC layer 42 is applied to an entire surface, and the OC layer 42 is formed. Next, the formed polarization layer 41 (for example, the LCLC layer) is patterned by dry etching or the like. After patterning, the material for the OC layer 42 is applied to an entire surface, and the OC layer 42 is further formed.

The circular polarizer according to the present invention obtained by the methods for manufacturing described above is suitably used in a display device using, for example, an organic or inorganic EL element or a light emitting diode element (LED).

### Eighth Embodiment: Display Device

A display device including the circular polarizer 1 according to the present invention is also within the scope of the present invention.

Hereinafter, “the same layer” means that the layer is formed in the same process, “a lower layer” means that the layer is formed in an earlier process than the process in which the layer to compare is formed, and “an upper layer” means that the layer is formed in a later process than the process in which the layer to compare is formed.

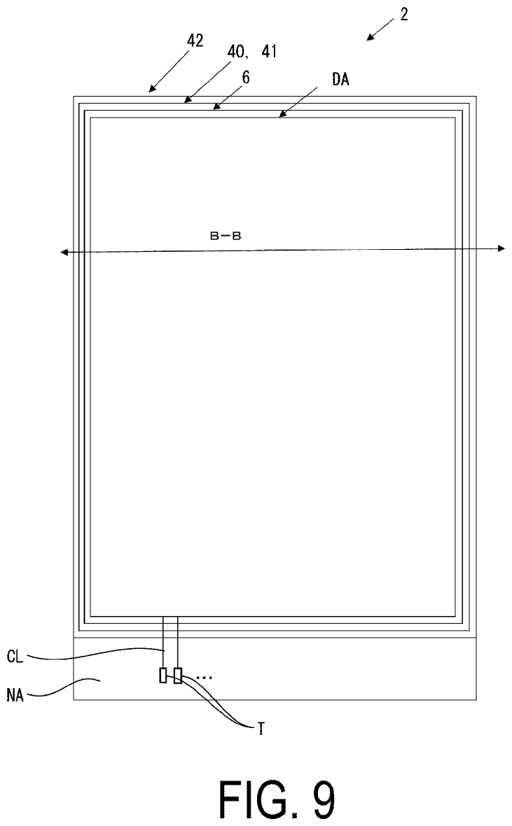

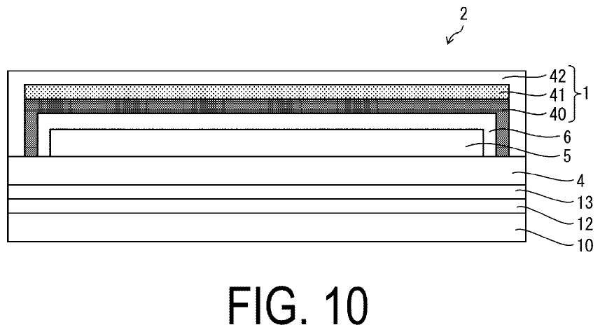

FIG. 9 is a top view of a display device 2 according to a seventh embodiment of the present invention. FIG. 10 is a cross-sectional view taken along a line B-B in FIG. 9. As illustrated in FIG. 9, the display device 2 according to the present embodiment includes a display region DA and a frame region NA around the display region DA. As illustrated in FIG. 9, a terminal portion T is formed at one end portion of the frame region NA. A driver (not illustrated) that supplies a signal for driving each light-emitting element in the display region DA via a connection wiring line CL from the display region DA, and the like are mounted on the terminal portion T.

Here, a configuration of each layer in the display region DA of the display device 2 according to the present embodiment will be described in detail with reference to FIG. 10.

As illustrated in FIG. 10, the display device 2 according to the present embodiment includes, in order from a lower layer, a lower face film 10, a resin layer 12, a barrier layer 13, a thin film transistor (TFT) layer 4, a light-emitting element layer 5, a sealing layer 6, and a circular polarizer 1. The circular polarizer 1 includes a λ/4 layer 40, and a polarization layer 41 that is layered on the λ/4 layer 40 and includes a lyotropic liquid crystal, and an OC layer 42 covering an upper surface and a side surface of the polarization layer 41 and a side surface of the λ/4 layer 40 is provided. The display device 2 may further include a function film having an optical compensation function, a touch sensor function, a protection function, and the like on the upper layer of the sealing layer 6 or the upper layer of the circular polarizer 1. The aspect described in the embodiments described above applies to the circular polarizer 1. Further, an adhesive layer may be provided between the lower face film 10 and the resin layer 12.

The lower face film 10 is a base material film of the display device 2, and may include, for example, an organic resin material. The resin layer 12 include polyimide as a material.

The barrier layer 13 is a layer that prevents foreign matter such as water and oxygen from penetrating the TFT layer 4 and the light-emitting element layer 5 when the display device 2 is used. The barrier layer 13 may be configured by a silicon oxide film, a silicon nitride film, or a silicon oxynitride film, or a layered film formed by layering these films formed by using CVD, for example.

In the circular polarizer 1 in the display device 2 according to the seventh embodiment, in an example, the polarization layer 41 and the λ/4 layer 40 may be formed between the sealing layer 6 and the light-emitting element layer 5 in a plan view of the display device 2. However, as illustrated in FIG. 10, it is suitable that the polarization layer 41 and the λ/4 layer 40 are formed so as to cover an entire surface of the sealing layer 6. In other words, in the plan view of the display device, an end portion of the polarization layer 41 is provided between the sealing layer 6 and the OC layer 42, and an end portion of the OC layer 42 on the terminal portion T side is provided between the polarization layer 41 and the terminal portion T. In this way, a stem wiring line that inputs power to the light-emitting element layer 5 is formed in the TFT layer 4 located in the sealing layer 6 outside the display region DA while suppressing a decrease in performance of the circular polarizer 1, but reflection of light due to the stem wiring line can be prevented.

### Ninth Embodiment: Method for Manufacturing Display Device

The method for manufacturing a display device according to the ninth embodiment includes a resin layer forming step of forming a resin layer, a barrier layer forming step of forming a barrier layer 13 on the resin layer 12, a thin film transistor (TFT) layer forming step of forming a TFT layer 4 on the barrier layer 13, a light-emitting element layer forming step of forming a light-emitting element layer 5, a sealing layer forming step of forming a sealing layer 6 on the light-emitting element layer 5, and a circular polarizer forming step of forming a circular polarizer 1 on the sealing layer. The circular polarizer 1 includes a λ/4 layer 40, and a polarization layer 41 that is layered on the λ/4 layer 40 and includes a lyotropic liquid crystal, and an OC layer 42 covering an upper surface and a side surface of the polarization layer 41 and a side surface of the λ/4 layer 40 is formed.

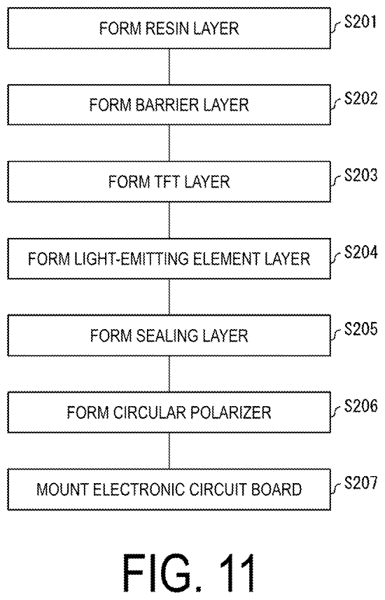

The method for manufacturing a display device according to the ninth embodiment will be described in detail with reference to a flowchart in FIG. 11.

First, the resin layer 12 is formed on a support substrate S (not illustrated) that is, for example, a transparent mother glass substrate (step S201). Next, the barrier layer 13 is formed (step S202). Next, the TFT layer 4 is formed in a layer above the barrier layer 13 (Step S203). At this time, a terminal portion T and a connection wiring line CL may be formed.

Next, the top-emitting type light-emitting element layer (for example, the OLED element layer) 5 is formed (step S204). In step S204, each layer of the light-emitting element layer 5 may be formed by a conventionally technique, and particularly, a light-emitting layer may be formed by vapor deposition or the like. Next, the sealing layer 6 is formed (step S205). Next, the polarizer 1 is formed (step S206). Next, an electronic circuit board (for example, an IC chip) is mounted on the terminal portion T to form a display device 2 (step S207). Note that the following steps may be included between step S205 and step S206.

For example, a step of bonding an upper face film to an upper surface of the sealing layer 6 is performed. Next, a step of peeling the support substrate S from the resin layer 12 is performed. Peeling of the support substrate S may be performed by, for example, a technique for irradiating a lower surface of the resin layer 12 with laser light over the support substrate S, reducing a bonding force between the support substrate S and the resin layer 12, and peeling the support substrate S from the resin layer 12.

Next, a step of bonding the lower face film 10 to a lower surface of each of the structures via an adhesive layer is performed. Next, the layered body from the lower face film 10 to the upper face film is divided to singulate the layered body. Next, a step of peeling the upper face film from the sealing layer 6, and then a step of bonding the circular polarizer 1 to an upper surface of each of the singulated layered bodies is performed.

A light-emitting element included in the display device according to the present embodiment is not particularly limited. Examples of the display device according to the present embodiment include an organic Electro Luminescence (EL) display provided with an Organic Light Emitting Diode (OLED) as the light-emitting element, an inorganic EL display provided with an inorganic light emitting diode as the light-emitting element, and a Quantum dot Light Emitting Diode (QLED) display provided with a QLED as the electro-optical element.

### Tenth Embodiment: Method for Manufacturing Display Device

In an example of a method for manufacturing a display device according to a tenth embodiment, the circular polarizer forming step described above includes a λ/4 layer forming step of forming the λ/4 layer 40 on the sealing layer 6 by application, a polarization layer forming step of forming the polarization layer 41 on the λ/4 layer 40 by application, and an OC layer forming step of forming the OC layer 42 on the upper surface and the side surface of the polarization layer 41 and the side surface of the λ/4 layer 40.

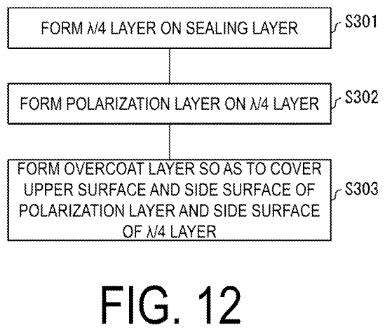

An example of the circular polarizer forming step of the method for manufacturing a circular polarizer according to the second embodiment will be described in detail with reference to a flowchart in FIG. 12.

First, for example, the λ/4 layer 40 is formed on the sealing layer 6 (step S301). Next, the polarization layer 41 is formed on the λ/4 layer 40 (step S302). Next, the OC layer 42 is formed so as to cover the upper surface and the side surface of the polarization layer 41 and the side surface of the λ/4 layer 40 (step S303).

### Exemplification of Specific Aspect according to the Present Invention

The present invention includes any of the following aspects.

### First Aspect

A circular polarizer, including:

a λ/4 layer; and

a polarization layer that is layered on the λ/4 layer and includes a lyotropic liquid crystal,

wherein an overcoat layer covering an upper surface and a side surface of the polarization layer and a side surface of the λ/4 layer is formed.

### Second Aspect

The circular polarizer according to aspect 1,

wherein an ultraviolet-curing resin material is used for the overcoat layer.

### Third Aspect

The circular polarizer according to aspect 1,

wherein a thermosetting resin material is used for the overcoat layer.

### Fourth Aspect

The circular polarizer according to any one of aspects 1 to 3,

wherein a thickness of the overcoat layer is 1 to 5 μm.

### Fifth Aspect

The circular polarizer according to any one of aspects 1 to 4,

wherein the λ/4 layer is a layered body of two λ/2 layers.

### Sixth Aspect

The circular polarizer according to any one of aspects 1 to 5,

wherein the lyotropic liquid crystal is a lyotropic chromonic liquid crystal.

### Seventh Aspect

A method for manufacturing a circular polarizer, including:

a λ/4 layer forming step of forming a λ/4 layer;

a polarization layer forming step of forming, on the λ/4 layer, a polarization layer including a lyotropic liquid crystal; and

an overcoat layer forming step of forming an overcoat layer covering an upper surface and a side surface of the polarization layer and a side surface of the λ/4 layer.

### Eighth Aspect

The method for manufacturing a circular polarizer according to aspect 7,

wherein, in the λ/4 layer forming step, the λ/4 layer is formed on a resin layer on a support substrate by application, and

in the polarization layer forming step, the polarization layer is formed on the λ/4 layer by application.

### Ninth Aspect

The method for manufacturing a circular polarizer according to aspect 7 or 8,

wherein, in the overcoat layer forming step, the overcoat layer is formed on, by application, an upper surface and a side surface of the polarization layer and a side surface of the λ/4 layer.

### Tenth Aspect

The method for manufacturing a circular polarizer according to any one of aspects 7 to 9, further including

a dividing step of dividing the circular polarizer,

wherein, in the overcoat layer forming step, the overcoat layer covering the upper surface of the polarization layer is provided, the circular polarizer is then divided, and the overcoat layer covering a side surface of the polarization layer and a side surface of the λ/4 layer after the division is further formed.

### Eleventh Aspect

The method for manufacturing a circular polarizer according to any one of aspects 7 to 9, further including

a dividing step of dividing the circular polarizer,

wherein the dividing step is performed by using a division blade, and a material for the overcoat layer is applied to the division blade, and,

in the overcoat layer forming step, the overcoat layer is formed by providing the overcoat layer covering an upper surface of the polarization layer, then dividing the circular polarizer with the division blade, and thus covering, with the material for the overcoat layer applied to the division blade, a side surface of the polarization layer and a side surface of the λ/4 layer.

### Twelfth Aspect

The method for manufacturing a circular polarizer according to any one of aspects 7 to 9, further including

a dividing step of dividing the circular polarizer,

wherein the dividing step is performed by using a division blade on which a material for the overcoat layer is not applied, and,

in the overcoat layer forming step, the overcoat layer is formed by providing the material for the overcoat layer covering an upper surface of the polarization layer, then dividing the circular polarizer with the division blade before the material for the overcoat layer is cured, and thus covering, with the material for the overcoat layer on the upper surface of the polarization layer, a side surface of the polarization layer and a side surface of the λ/4 layer.

### Thirteenth Aspect

The method for manufacturing a circular polarizer according to any one of aspects 7 to 12, further including

a liquid repellent layer forming step of forming, between the overcoat layer and the λ/4 layer, a liquid repellent layer that repels the material for the overcoat layer,

wherein a plurality of circular polarizers are layered together and formed with the liquid repellent layer interposed between two circular polarizers.

### Fourteenth Aspect

A display device including the circular polarizer according to any one of aspects 1 to 6.

### Fifteenth Aspect

The display device according to aspect 14,

wherein a sealing layer covering an entire surface of a light-emitting element layer is provided,

in a plan view of the display device, an end portion of the polarization layer is provided between the sealing layer and the overcoat layer, and

an end portion of the overcoat layer on a terminal portion side is provided between the polarization layer and the terminal portion.

### Sixteenth Aspect

A method for manufacturing a display device, including:

a resin layer forming step of forming a resin layer;

a barrier layer forming step of forming a barrier layer on the resin layer;

a thin film transistor (TFT) layer forming step of forming a TFT layer on the barrier layer;

a light-emitting element layer forming step of forming a light-emitting element layer;

a sealing layer forming step of forming a sealing layer on the light-emitting element layer; and

a circular polarizer forming step of forming a circular polarizer on the sealing layer,

wherein the circular polarizer includes a λ/4 layer, and a polarization layer that is layered on the λ/4 layer and includes a lyotropic liquid crystal, and

an overcoat layer covering an upper surface and a side surface of the polarization layer and a side surface of the λ/4 layer is formed.

### Seventeenth Aspect

The method for manufacturing a display device according to aspect 16,

wherein the circular polarizer forming step includes

a λ/4 layer forming step of forming the λ/4 layer on the sealing layer by application,

a polarization layer forming step of forming the polarization layer on the λ/4 layer by application, and

an overcoat layer forming step of forming the overcoat layer on an upper surface and a side surface of the polarization layer and a side surface of the λ/4 layer.

The present invention is not limited to each of the embodiments described above, and various modifications may be made within the scope of the aspects. Embodiments obtained by appropriately combining technical approaches disclosed in each of the different embodiments also fall within the technical scope of the present invention. Furthermore, novel technical features can be formed by combining the technical approaches disclosed in the embodiments.

### REFERENCE SIGNS LIST

1 Circular polarizer

2 Display device

4 TFT layer (thin film transistor layer)

5 Light-emitting element layer

6 Sealing layer

10 Lower face film

12 Resin layer

13 Barrier layer

36 Liquid repellent layer

38 Support substrate

39 Resin layer

40 λ/4 layer

41 Polarization layer

42 Overcoat layer (OC layer)

50 Division blade

DA Display region

NA Frame region

T Terminal portion

CL Connection wiring line

1. A circular polarizer, comprising:
a λ/4 layer; and
a polarization layer that is layered on the λ/4 layer and includes a lyotropic liquid crystal,
wherein an overcoat layer covering an upper surface and a side surface of the polarization layer and a side surface of the λ/4 layer is formed.

2. The circular polarizer according to claim 1,
wherein an ultraviolet-curing resin material is used for the overcoat layer.

3. The circular polarizer according to claim 1,
wherein a thermosetting resin material is used for the overcoat layer.

4. The circular polarizer according to claim 1,
wherein a thickness of the overcoat layer is 1 to 5 μm.

5. The circular polarizer according to claim 1,
wherein the λ/4 layer is a layered body of two λ/2 layers.

6. The circular polarizer according to claim 1,
wherein the lyotropic liquid crystal is a lyotropic chromonic liquid crystal.

7. A method for manufacturing a circular polarizer, comprising:
a λ/4 layer forming step of forming a λ/4 layer;
a polarization layer forming step of forming, on the λ/4 layer, a polarization layer including a lyotropic liquid crystal; and
an overcoat layer forming step of forming an overcoat layer covering an upper surface and a side surface of the polarization layer and a side surface of the λ/4 layer.

8. The method for manufacturing a circular polarizer according to claim 7,
wherein, in the λ/4 layer forming step, the λ/4 layer is formed on a resin layer on a support substrate by application, and
in the polarization layer forming step, the polarization layer is formed on the λ/4 layer by application.

9. The method for manufacturing a circular polarizer according to claim 7,
wherein, in the overcoat layer forming step, the overcoat layer is formed on, by application, an upper surface and a side surface of the polarization layer and a side surface of the λ/4 layer.

10. The method for manufacturing a circular polarizer according to claim 7, further comprising
a dividing step of dividing the circular polarizer,
wherein, in the overcoat layer forming step, the overcoat layer covering the upper surface of the polarization layer is provided, the circular polarizer is then divided, and the overcoat layer covering a side surface of the polarization layer and a side surface of the λ/4 layer after the division is further formed.

11. The method for manufacturing a circular polarizer according to claim 7, further comprising
a dividing step of dividing the circular polarizer,
wherein the dividing step is performed by using a division blade, and a material for the overcoat layer is applied to the division blade, and,
in the overcoat layer forming step, the overcoat layer is formed by providing the overcoat layer covering an upper surface of the polarization layer, then dividing the circular polarizer with the division blade, and thus covering, with the material for the overcoat layer applied to the division blade, a side surface of the polarization layer and a side surface of the λ/4 layer.

12. The method for manufacturing a circular polarizer according to claim 7, further comprising
a dividing step of dividing the circular polarizer,
wherein the dividing step is performed by using a division blade on which a material for the overcoat layer is not applied, and,
in the overcoat layer forming step, the overcoat layer is formed by providing the material for the overcoat layer covering an upper surface of the polarization layer, then dividing the circular polarizer with the division blade before the material for the overcoat layer is cured, and thus covering, with the material for the overcoat layer on the upper surface of the polarization layer, a side surface of the polarization layer and a side surface of the λ/4 layer.

13. The method for manufacturing a circular polarizer according to claim 7, further comprising
a liquid repellent layer forming step of forming, between the overcoat layer and the λ/4 layer, a liquid repellent layer that repels the material for the overcoat layer,
wherein a plurality of circular polarizers are layered together and formed with the liquid repellent layer interposed between two circular polarizers.

14. A display device comprising the circular polarizer according to claim 1.

15. The display device according to claim 14,
wherein a sealing layer covering an entire surface of a light-emitting element layer is provided,
in a plan view of the display device, an end portion of the polarization layer is provided between the sealing layer and the overcoat layer, and
an end portion of the overcoat layer on a terminal portion side is provided between the polarization layer and the terminal portion.

16. A method for manufacturing a display device, comprising:
a resin layer forming step of forming a resin layer;
a barrier layer forming step of forming a barrier layer on the resin layer;
a thin film transistor (TFT) layer forming step of forming a TFT layer on the barrier layer;
a light-emitting element layer forming step of forming a light-emitting element layer;
a sealing layer forming step of forming a sealing layer on the light-emitting element layer; and
a circular polarizer forming step of forming a circular polarizer on the sealing layer,
wherein the circular polarizer includes a λ/4 layer, and a polarization layer that is layered on the λ/4 layer and includes a lyotropic liquid crystal, and
an overcoat layer covering an upper surface and a side surface of the polarization layer and a side surface of the λ/4 layer is formed.

17. The method for manufacturing a display device according to claim 16,
wherein the circular polarizer forming step includes
a λ/4 layer forming step of forming the λ/4 layer on the sealing layer by application,
a polarization layer forming step of forming the polarization layer on the λ/4 layer by application, and
an overcoat layer forming step of forming the overcoat layer on an upper surface and a side surface of the polarization layer and a side surface of the λ/4 layer.
